(19) United States
(12) Patent Application Publication
(10) Pub. No.: US 2024/0354414 A1
(43) Pub. Date: Oct. 24, 2024

(54) Method, Device, and Computer-Readable Storage Medium for Managing Processes

(71) Applicant: Robert Bosch GmbH, Stuttgart (DE)

(72) Inventors: Yan CHEN, Suzhou (CN); Yongzheng SHI, Suzhou (CN)

(21) Appl. No.: 18/638,921

(22) Filed: Apr. 18, 2024

(30) Foreign Application Priority Data
Apr. 20, 2023 (CN) 2023 1042 9816.5

(51) Int. Cl. G06F 21/57

(52) U.S. Cl. CPC G06F 21/57

(57) ABSTRACT

A method, a device, and a computer-readable storage medium for managing processes are disclosed. The method includes (i) determining a trigger frequency at which a process is activated due to receipt of data within a preset duration, (ii) adjusting a current trust value corresponding to the process based on the trigger frequency, wherein the current trust value is used to indicate the degree of trustworthiness when the process is currently in the normal state, and (iii) managing the state of the process based on the adjusted result of the trust value.

This application claims priority under 35 U.S.C. § 119 to patent application no. CN 2023 1042 9816.5, filed on Apr. 20, 2023 in China, the disclosure of which is incorporated herein by reference in its entirety.

The present disclosure relates to the field of information technology, in particular to a method, a device, and a computer-readable storage medium for managing processes.

### BACKGROUND

When many computing systems are running, a plurality of different processes are typically required to execute the corresponding tasks. In general, the system may allocate the corresponding operational resources at the startup of each process such that the process may utilize the allocated operational resources to carry out the corresponding activities. The state of the process is typically closely related to the processing load and processing performance of the system. Thus, how to efficiently manage processes is one of the issues that needs to be addressed.

### SUMMARY

In view of the need for prior art improvements, examples of the present disclosure provide a method, a device, and a computer-readable storage medium for managing processes.

In one aspect, the examples of the present disclosure provide a method for managing processes, including determining a trigger frequency at which a process is activated due to receipt of data within a preset duration; adjusting the current trust value corresponding to the process based on the trigger frequency, wherein the current trust value is used to indicate the degree of trustworthiness when the process is currently in the normal state; and managing the state of the process based on the adjusted result of the trust value.

In another aspect, the examples of the present disclosure provide a device for managing processes, including a determination unit configured to determine a trigger frequency at which a process is activated due to receipt of data within a preset duration; an adjustment unit configured to adjust the current trust value corresponding to the process based on the trigger frequency, wherein the current trust value is used to represent the degree of trustworthiness when the process is currently in the normal state; and a management unit configured to manage the state of the process based on the adjusted result of the current trust value.

In another aspect, the examples of the present disclosure provide a device for managing processes, including at least one processor; a memory in communication with the at least one processor, wherein the memory stores an executable code thereon, and the executable code, when executed by the at least one processor, allows the at least one processor to perform the above-mentioned method.

In another aspect, the examples of the present disclosure provide a computer-readable storage medium which stores an executable code that, when executed, implements the above-mentioned method.

### BRIEF DESCRIPTION OF THE DRAWINGS

A more detailed description of the examples of the present disclosure is provided with reference to the accompanying drawings, in which the above-mentioned and other purposes, features, and advantages of the examples of the present disclosure will become more apparent, wherein in the various accompanying drawings, the same reference numerals generally represent the same elements.

FIG. 1 is a schematic flow diagram of a method for managing processes according to an example of the present disclosure.

FIG. 2 shows an example of a computing system that may be applied according to an example of the present disclosure.

FIGS. 3A and 3B show schematic flow diagrams of a process of managing processes under the architecture shown in FIG. 2.

FIG. 4 is a schematic block diagram of a device for managing processes according to some examples.

FIG. 5 is a schematic structural diagram of a device for managing processes according to some examples.

### DETAILED DESCRIPTION

The subject matter described herein is hereby discussed with reference to various examples. It should be understood that discussions about these examples are provided to aid those skilled in the art in better understanding and implementation of the subject matter described herein rather than limiting the scope of protection, applicability, or examples described in the claims.

In many computing systems, a plurality of processes are typically required to execute the corresponding tasks. The corresponding operational resources are allocated at the startup of different processes. Currently, in some computing systems, a process may be in the non-run state when no task or data is required to be executed or processed; and when data is received, the corresponding process may be activated to enter the run state.

For example, in some self-driving computing systems, processes are managed through the use of middleware, such as middleware that may be referred to as automation operating system (AOS) middleware. In some implementations, the AOS middleware may include an execution and state management (ESEM) module and an activity decentralized activation management (ADAM) module. The ESEM module may start up processes in the self-driving computing system and monitor the state of the processes. The ADAM module may activate the running of processes, such as when data is received at the receiving port thereof.

However, in some cases, there may be some problems with the running of processes. For example, as a process is activated when the data is received, if data is received frequently, the process may be activated frequently. For example, in the case of a replay attack, an attacker may send data to the computing system very frequently, thereby activating the process frequently. In this way, the process may consume a significant amount of operational resources, resulting in an overly high load on the computing system, which can lead to the computing system crashing in serious cases. For example, if this occurs in the above-mentioned self-driving computing system, it may affect the normal running of the self-driving computing system and the normal operation of the vehicle in serious cases.

To this end, the examples of the present disclosure provide a technical solution for managing processes. The description is given below with reference to the specific examples.

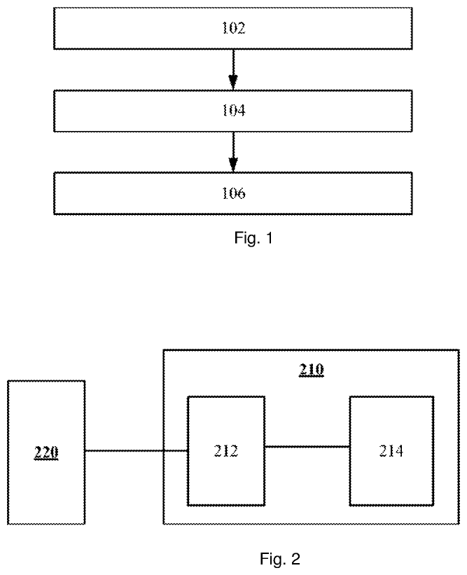

FIG. 1 is a schematic flow diagram of a method for managing processes according to an example of the present disclosure.

In step 102, a trigger frequency at which a process is activated due to receipt of data within a preset duration may be determined. For example, as previously described, upon receiving data, the corresponding process may be activated. In this case, in step 102, the frequency at which the process is triggered by the data within the preset duration may be determined.

In step 104, the current trust value corresponding to the process may be adjusted based on the trigger frequency.

In the examples of the present disclosure, a process may correspond to a trust value. The trust value may represent the degree of trustworthiness when the process is in the normal state. The trust value may change as the state of the process changes. Thus, the current trust value may be used to represent the degree of trustworthiness when the process is currently in the normal state.

In step 106, the state of the process may be managed based on the adjusted result of the current trust value.

In the examples of the present disclosure, the trigger frequency of the process within the preset duration may be determined and then the current trust value corresponding to the process is adjusted based on the trigger frequency. Since the current trust value may be used to represent the degree of trustworthiness when the process is currently in the normal state, based on the adjusted result of the current trust value, the degree of trustworthiness when the process is in the normal state may be determined, thereby enabling further efficient management of the state of processes. It can be seen that in this way, process state exceptions (e.g., due to attacks and the like) may be detected in a timely manner so that the state of processes may be managed in a timely and effective manner, thereby avoiding some potential problems. For example, it is possible to avoid frequent activation of processes, which consume large amounts of operational resources, thereby avoiding issues such as overly high load or crashing of the computing system.

In some examples, the above-mentioned preset duration may be set according to various factors, such as specific application scenarios, business needs, and the like. The present disclosure does not define this aspect.

In some examples, various appropriate methods may be used to determine the trigger frequency. For example, in some implementations, the trigger frequency may be calculated based on the preset duration and a rate at which data is received within the preset duration. For example, the trigger frequency may be expressed as m triggers per unit of time (m is a positive integer). Of course, in different embodiments, other means may be used to represent the trigger frequency, which is not defined herein.

In some examples, in step 104, if the trigger frequency is greater than the frequency threshold, the current trust value may be reduced to obtain a first trust value. For example, where the trust value is an integer, if the trigger frequency is greater than the frequency threshold, the current trust value may be reduced by 1. Of course, the trust value may be set to any number format, which is not defined herein. The state of the process may then be managed based on the first trust value.

In this case, the state of the process may be managed based on the relationship between the first trust value and a first trust threshold, as well as a second trust threshold. The first trust threshold may be greater than the second trust threshold. The first trust threshold and the second trust threshold may be preset based on a variety of factors, such as application scenarios, business needs, and the like. For example, the first trust threshold may be 5 and the second trust threshold may be 0. Of course, the first trust threshold and the second trust threshold may have other values and/or other number formats in different implementations, which are not defined herein.

For example, in step 106, the process may be rebooted if the first trust value is less than the first trust threshold and is greater than or equal to the second trust threshold. As previously described, the trust value may represent the degree of trustworthiness when the process is in the normal state. If the first trust value obtained after reducing the current trust value is less than the first trust threshold and greater than or equal to the second trust threshold, the degree of trustworthiness of the process in the normal state is typically considered to not be very high, so the process may be rebooted to avoid the process from possibly occupying a large amount of resources and thereby affecting the computing system performance.

For example, in step 106, if the first trust value is less than the second trust threshold, the process may have affected the performance of the system. For further determination, the state of the process may be managed based on the initial check code and the current check code of the process. For example, the current check code and the initial check code for the process may be determined. The initial check code may be a check code at the initial startup of the process. Correspondingly, the current check code may be the current check code of the process. In the normal state, the check code is unique to the process. For example, the check code may be an advanced encryption standard (AES)-256 checksum for the process. Of course, in different implementations, the check code may be obtained in various ways, which are not defined herein. For example, a cyclic redundancy check (CRC), message-digest algorithm 5 (MD5), secure hash algorithm (SHA), or any other custom algorithms may also be employed to determine the check code for the process.

Thus, the state of the process may be managed based on a comparison of the current check code and the initial check code. For example, if the current check code is consistent with the initial check code, it indicates that the process is not tampered with by the attacker and the process may be rebooted to mitigate the issue of the consumption of a large amount of operational resources by the process.

For example, if the current check code is inconsistent with the initial check code, it indicates that the process may be tampered with by the attacker, and has become unsecure and affects system performance. In this case, the process may be terminated.

Further, in some implementations, where the first trust value is less than the second trust threshold, considering the potential risk, an error report may be generated for the process, regardless of whether the current check code is consistent or inconsistent with the initial check code. The error report may be sent to the user for the user to take further action.

As previously described, the initial check code is the check code at the initial startup of the process. To ensure the reliability and security of the initial check code, the initial check code may be stored in a hardware security module (HSM) at the initial startup of the process. The HSM is chip-based and tamper-resistant, so storing the initial check code in the HSM ensures the security and reliability of the initial check code, thereby ensuring the reliability of subsequent checking processes.

In some examples, regardless of in which of the above-mentioned situations the process is rebooted, the trust value corresponding to the process after the reboot may still be the first trust value. In particular, the trust value corresponding to the process after the reboot may still be the trust value at the time of reboot, rather than the initial trust value, which enables effective monitoring of the state of the process.

In some examples, if the trigger frequency is less than or equal to the frequency threshold and the current trust value is greater than the first trust threshold and less than the initial trust value, it represents that the process is currently in the normal state. In this case, the current trust value may be increased to obtain a second trust value. The initial trust value may be the corresponding trust value at the initial startup of the process. For example, the initial trust value may be 10.

Of course, this is merely an example, and in different implementations, the initial trust value may have other values and/or other number formats. In such cases, the current state of the process may be maintained based on the second trust value.

In some examples, if the trigger frequency is less than or equal to the frequency threshold and the current trust value is equal to the initial trust value, it represents that the process is currently in the normal state. In this case, the current trust value may remain unchanged and the current state of the process may be maintained.

In some examples, the initial trust value may be stored in the HSM. As previously described, similar to the initial check code, storing the initial trust value into the HSM ensures the security and reliability of the initial trust value. The initial trust value may be obtained from the HSM when the initial trust value is required in the foregoing process.

The examples of the present disclosure will be described below with reference to the specific examples. It should be understood that the following examples are merely intended to help those skilled in the art better understand the examples of the present disclosure without limiting the scope thereof.

The following examples will be described with reference to the AOS middleware in the above-described self-driving computing system.

FIG. 2 shows an example of a computing system that may be applied according to an example of the present disclosure.

As shown in FIG. 2, the computing system may include an AOS middleware 210 and an HSM 220. It should be understood that only some of the modules relevant to the examples of the present disclosure are shown here. In real life, the computing system may further include various other modules, which are not defined herein.

The AOS middleware 210 may include an ESEM module 212 and an ADAM module 214. The ESME module 212 may start up and monitor processes. The ADAM module 214 may activate the corresponding process upon receiving data.

Further, the ESME module 212 may also interact with the HSM 220 to exchange corresponding information with the HSM 220.

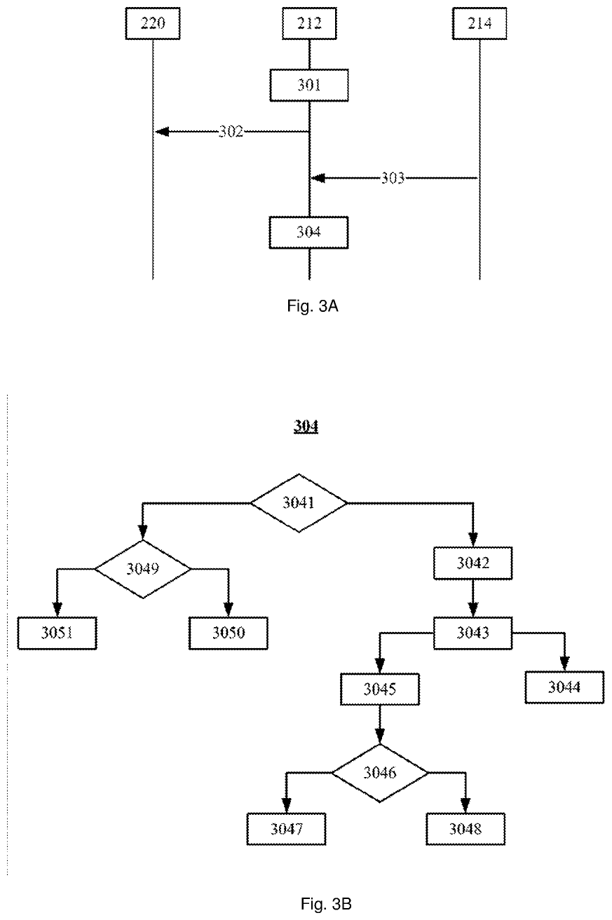

FIGS. 3A and 3B show schematic flow diagrams of a process of managing processes under the architecture shown in FIG. 2.

As shown in FIG. 3A, in step 301, the ESME module 212 may start up a process and determine the initial trust value corresponding to the process and the initial check code for the process.

For example, the initial trust value may be preset, such as based on a variety of factors such as actual application scenarios, business needs, and the like. For example, the initial trust value may be 10. The initial check code may be unique to the process. For example, the initial check code may be an AES-256 checksum of the process.

In step 302, the ESME module 212 may send the initial trust value and the initial check code to the HSM 220 so that the HSM 220 stores the initial trust value and the initial check code, thereby ensuring the security of the initial trust value and the initial check code.

At some time during the running of the system, the process begins to be activated. So, in step 303, the ADAM module 214 may report to the ESME module 212 the trigger frequency at which the process is activated by the data within the preset duration.

In step 304, the ESME module 212 may execute some operations based on the trigger frequency to manage the state of the process.

FIG. 3B shows a schematic flow diagram of a specific process in step 304 of FIG. 3A.

As shown in FIG. 3B, in step 3041, the ESME module 212 may determine whether the trigger frequency is greater than the frequency threshold.

If the trigger frequency is greater than the frequency threshold, in step 3042, the ESME module 212 may reduce the current trust value of the process to obtain a first trust value. For example, at the initial startup of the process, the current trust value of the process may be equal to the initial trust value.

In step 3043, the ESME module 212 may determine the relationship between the first trust value and the first trust threshold, as well as the second trust threshold.

If the first trust value is less than the first trust threshold and is greater than or equal to the second trust threshold, in step 3044, the ESME module 212 may reboot the process. For example, the first trust threshold may be 5 and the second trust threshold may be 0.

If the first trust value is less than the second trust threshold, in step 3045, the ESME module 212 may obtain the initial check code for the process from the HSM 220 and determine the current check code for the process.

In step 3046, the ESME module 212 may determine if the current check code of the process is consistent with the initial check code.

If the current check code is consistent with the initial check code, in step 3047, the ESME module 212 may reboot the process. If the current check code is inconsistent with the initial check code, in step 3048, the ESME module 212 may terminate the process.

Further, in both step 3047 and step 3048, the ESME module 212 may generate an error report for the process and send the error report to the user considering that the first trust value is relatively low, i.e., the degree of trustworthiness when the process is in the normal state is relatively low.

Returning to the front, if the trigger frequency is less than or equal to the frequency threshold, in step 3049, the ESME module 212 may determine if the current trust value is equal to or less than the initial trust value.

If the current trust value is less than the initial trust value, in step 3050, the ESME module 212 may increase the current trust value to obtain a second trust value. For example, the current trust value may be increased by 1. Further, the ESME module 212 maintains the current state of the process based on the second trust value.

If the current trust value is equal to the initial trust value, in step 3051, the ESME module 212 may maintain the current trust value and maintain the current state of the process.

As previously described, the initial trust value may be stored in the HSM 220. Thus, the ESME module 212 may obtain the initial trust value from the HSM 220 when the initial trust value is required in the above-mentioned steps.

It can be seen that the ESME module 212 may work with the ADAM module 214 and the HSM 220 throughout the process to dynamically monitor the state of the process and take appropriate action (e.g., reboot or terminate) when a process exception is found. Thus, it is possible to ensure normal running of the computing system. The above-mentioned processes may be executed continuously and dynamically so as to be able to continuously manage the state of the process.

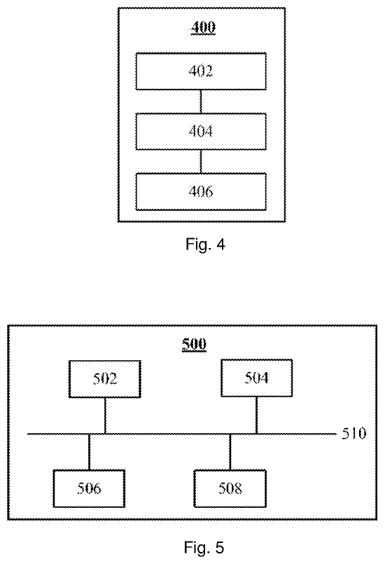

FIG. 4 is a schematic block diagram of a device for managing processes according to some examples.

As shown in FIG. 4, a device 400 may include a determination unit 402, an adjustment unit 404, and a management unit 406.

The determination unit 402 may determine a trigger frequency at which a process is activated due to receipt of data within a preset duration. The adjustment unit 404 may adjust the current trust value corresponding to the process based on the trigger frequency, wherein the current trust value may be used to represent the degree of trustworthiness when the process is currently in the normal state. The management unit 406 may manage the state of the process based on the adjusted result of the current trust value.

The individual units of the device 400 may execute specific processes described above in the examples of the method. Thus, for brevity, the specific operations and functions of the individual units of device 400 will not be repeated herein.

FIG. 5 is a schematic structural diagram of a device for managing processes according to some examples.

As shown in FIG. 5, a device 500 may include a processor 502, a memory 504, an input interface 506, and an output interface 508, and these modules may be coupled together via a bus 510 However, it should be understood that FIG. 5 is for illustrative purposes only and does not limit the scope of the present disclosure. For example, in different application scenarios, the device 500 may include more or fewer modules, which is not limited herein.

The memory 504 may be used to store various information, executable instructions, codes, or the like related to the functions or operations of the device 500.

For example, the memory 504 may include, but is not limited to, random access memory (RAM), read-only memory (ROM), flash memory, programmable ROM (PROM), erasable PROM (EPROM), registers, hard disks, and the like.

The processor 502 may be used to execute or implement various functions or operations of the device 500, such as the various operations described in this disclosure. For example, the processor 502 may execute executable instructions or code stored in the memory 504 to implement various processes described above in the examples of the method. The processor 502 may include various applicable processors, such as a general-purpose processors (e.g., central processing unit, CPU), and specialized processors (e.g., digital signal processors, application-specific integrated circuits, and the like).

The input interface 506 may receive various forms of information, data, or the like. In some embodiments, the input interface 506 may facilitate communication based on various applicable communication standards.

The output interface 508 may output various forms of information, data, or the like. In some embodiments, the output interface 508 may facilitate communication based on various applicable communication standards.

The examples of the present disclosure further provide a computer-readable storage medium. The computer-readable storage medium is capable of storing executable codes, which when executed implement the above specific processes described above in the examples of the method.

For example, the computer-readable storage medium may include, but is not limited to, RAM, ROM, electrically-erasable programmable read-only memory, EEPROM, static random access memory, SRAM, hard disk, flash memory, and the like.

The above-described specific examples of the present disclosure have been described. Other examples are within the scope of the appended claims. In some cases, actions or steps described in the claims can be performed in a different order than that of the examples and still achieve the desired results. Further, the processes depicted in the accompanying drawings do not necessarily require a specific sequence or continuous sequence to achieve the desired results. In some embodiments, multitasking and parallel processing are also possible or advantageous.

Not all steps and units depicted in the above-mentioned flowcharts and system diagrams are required; certain steps or units may be omitted based on actual needs. The device structures in the above-mentioned examples may be physical or logical, i.e., some units may be implemented by the same physical entity, while others may be implemented by a plurality of physical entities or may be jointly implemented by certain components in a plurality of separate devices

The above, with reference to the accompanying drawings, details various optional embodiments of the present disclosure. However, the examples of the present disclosure are not limited to the specific details of the embodiments mentioned above. Within the scope of the technical concept of the examples of the present disclosure, various modifications to the technical solutions of the examples of the present disclosure are possible, and these modifications fall within the scope of protection of the examples of the present disclosure.

What is claimed is:

1. A method for managing processes, comprising:
determining a trigger frequency at which a process is activated due to receipt of data within a preset duration;
adjusting a current trust value corresponding to the process based on the trigger frequency, wherein the current trust value is used to represent a degree of trustworthiness when the process is currently in a normal state; and
managing the state of the process based on the adjusted result of the current trust value.

2. The method according to claim 1, wherein:
adjusting the current trust value corresponding to the process includes reducing the current trust value if the trigger frequency is greater than the frequency threshold to obtain a first trust value, and
managing the state of the process includes managing the state of the process based on the first trust value.

3. The method according to claim 2, wherein managing the state of the process based on the first trust value includes:
rebooting the process if the first trust value is less than the first trust threshold and is greater than or equal to a second trust threshold, wherein the first trust threshold is greater than the second trust threshold; and
if the first trust value is less than the second trust threshold,
determining the current check code and initial check code of the process, wherein the initial check code is the check code at the initial startup of the process; and
managing the state of the process based on a comparison of the current check code and the initial check code.

4. A method according to claim 3, wherein managing the state of the process based on a comparison of the current check code and the initial check code includes:
rebooting the process if the current check code is consistent with the initial check code; and
terminating the process if the current check code is inconsistent with the initial check code.

5. The method according to claim 3, further comprising:
storing the initial check code in a hardware security module at the initial startup of the process; and
determining the initial check code, including obtaining the initial check code from the hardware security module.

6. The method according to claim 3, wherein the trust value corresponding to the process after the reboot is the first trust value.

7. The method according to claim 1, wherein:
adjusting the current trust value corresponding to the process includes increasing the current trust value to obtain the second trust value if the trigger frequency is less than or equal to the frequency threshold and the current trust value is greater than the first trust threshold and less than the initial trust value, wherein the initial trust value is the corresponding trust value at the initial startup of the process; and
managing the state of the process includes maintaining the current state of the process based on the second trust value.

8. The method according to claim 1, wherein:
adjusting the current trust value corresponding to the process includes the current trust value remaining unchanged if the trigger frequency is less than or equal to the frequency threshold, and the current trust value is equal to the initial trust value, wherein the initial trust value is the corresponding trust value at the initial startup of the process; and
managing the state of the process includes maintaining the current state of the process.

9. The method according to claim 7, further comprising:
storing the initial trust value in the hardware security module at the initial startup of the process.

10. A device for managing processes, comprising:
a determination unit configured to determine a trigger frequency at which a process is activated due to receipt of data within a preset duration;
an adjustment unit configured to adjust a current trust value corresponding to the process based on the trigger frequency, wherein the current trust value is used to represent a degree of trustworthiness when the process is currently in a normal state; and
a management unit configured to manage the state of the process based on the adjusted result of the current trust value.

11. A device for managing processes, comprising:
at least one processor; and
a memory in communication with the at least one processor, wherein the memory stores an executable code thereon, and the executable code, when executed by the at least one processor, allows the at least one processor to perform the method according to claim 1.

12. A computer-readable storage medium storing executable code, wherein the executable code, when executed, causes a computer to perform the method according to claim 1.
